(19) United States
(12) Patent Application Publication
(10) Pub. No.: US 2010/0294294 A1
(43) Pub. Date: Nov. 25, 2010

(54) Dental floss strip, dental floss pick and method for manufacturing the bactericidal dental floss pick

(76) Inventor: Chien-Chung Wu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/453,678

(22) Filed: May 19, 2009

(51) Int. Cl. A61C 15/00; A61C 15/04; A61C 15/02

(52) U.S. Cl. 132/200; 132/323; 132/321

(57) ABSTRACT

A dental floss pick with a bactericidal function includes a support body and a plurality of dental silks. The support body has a support portion and at least two suspended portions separated from each other and parallelly extended outwards from the support portion. Each dental silk has two ends respectively fixed on the two suspended portions. Each dental silk is composed of a first dental material and a second dental material, and the second dental material is composed of a plurality of nano-sized silver particles that are mixed into the first dental material. Therefore, when the twisted dental silks are stirred by a predetermined force, one part of the nano-sized silver particles that have been mixed in the first dental material may be separated from the first dental material.

### BACKGROUND OF THE INVENTION

1. Field of the Invention

The present invention relates to a dental floss strip, a dental floss pick and a method for manufacturing the dental floss pick, in particular, to a dental floss strip with bactericidal function, a dental floss pick with bactericidal function and a method for manufacturing the bactericidal dental floss pick.

2. Description of Related Art

As is well known, oral hygiene is very important. A basic approach to maintain a well oral hygiene is to brush teeth after every meal. However, it is difficult to brush teeth everywhere after a meal and is not easy to scale the teeth by brushing. Therefore, for the importance of oral hygiene, dentists appeal to everyone to brush teeth cooperatively with picking teeth by dental floss. Conventional dental floss holder is generally classified to two types: one is spooling type and the other one is U-shaped type; dental floss of the preceding type is reeled in a spool, when use, users have to draw the floss and tighten the floss up to scale teeth; in this way to clean teeth particularly requires cleanness of hands, or oral hygiene may be affected; besides rear molar teeth are difficult to clean in this way since manipulation angles.

As to the U-shaped dental floss holder, dental floss of the U-shaped holder is being fixed on a gap of the U-shaped holder, when use, users can put the gap of the U-shaped holder into a mouth without using the users' finger inside the mouth; therefore, the finger will not touch floss directly. However, rear molar teeth are still hard to be cleaned due to the manipulation angles of using the U-shaped dental floss holder. Furthermore, the U-shaped dental floss holder is usually thrown away after cleaning, which may cause garbage pollution and waste resources; so, aforementioned two types of dental floss holder need to be improved.

### SUMMARY OF THE INVENTION

In view of the aforementioned issues, the present invention provides a dental floss strip with bactericidal function, a dental floss pick with bactericidal function and a method for manufacturing the bactericidal dental floss pick. When nano-sized silver particles that have been mixed in the dental floss strip of the dental floss pick are separated from the dental floss strip, the nano-sized silver particles can kill bacteria in the oral cavity in order to avoid periodontal disease. When the dental floss pick is abandoned, the dental floss pick does not pollute environment in order to achieve environmental effect.

To achieve the above-mentioned objectives, the present invention provides a dental floss strip applied to a dental floss pick. The dental floss strip includes a plurality of dental silks twisted with each other. Each dental silk is composed of a first dental material and a second dental material, the second dental material is composed of a plurality of nano-sized silver particles that are mixed into the first dental material. Therefore, when the twisted dental silks are stirred by a predetermined force, one part of the nano-sized silver particles that have been mixed in the first dental material may be separated from the first dental material.

To achieve the above-mentioned objectives, the present invention provides a dental floss pick with a bactericidal function. The dental floss pick includes a support body and a plurality of dental silks. The support body has a support portion and at least two suspended portions separated from each other and parallelly extended outwards from the support portion. Each dental silk has two ends respectively fixed on the two suspended portions. Each dental silk is composed of a first dental material and a second dental material, and the second dental material is composed of a plurality of nano-sized silver particles that are mixed into the first dental material. Therefore, when the twisted dental silks are stirred by a predetermined force, one part of the nano-sized silver particles that have been mixed in the first dental material may be separated from the first dental material.

To achieve the above-mentioned objectives, the present invention provides a method for manufacturing a dental floss pick with a bactericidal function. The method includes providing a support body that has a support portion and at least two suspended portions separated from each other and parallelly extended outwards from the support portion; providing a plurality of dental silks, each dental silk being composed of a first dental material and a second dental material, and the second dental material being composed of a plurality of nano-sized silver particles that are mixed into the first dental material; and then fixing two ends of each dental silk respectively on the two suspended portions, so that when the twisted dental silks are stirred by a predetermined force, one part of the nano-sized silver particles that have been mixed in the first dental material may be separated from the first dental material.

Therefore, when the dental floss strip is applied to clean teeth, the dental floss strip can generate bactericidal function. Hence, when one part of the nano-sized silver particles that have been mixed in the first dental material is separated from the first dental material, the nano-sized silver particles can kill bacteria in the oral cavity in order to avoid periodontal disease. For example, when a user uses the dental floss strip to clean teeth, one part of the nano-sized silver particles that have been mixed in the first dental material is separated from the first dental material by vibrating the dental floss strip in order to achieve bactericidal activity.

In order to further understand the techniques, means and effects the present invention takes for achieving the prescribed objectives, the following detailed descriptions and appended drawings are hereby referred, such that, through which, the purposes, features and aspects of the present invention can be thoroughly and concretely appreciated; however, the appended drawings are merely provided for reference and illustration, without any intention to be used for limiting the present invention.

### BRIEF DESCRIPTION OF THE DRAWINGS

FIG. 1A is an exploded, schematic view of the dental floss strip applied to a dental floss pick according to the present invention;

FIG. 1B is an enlarged, schematic view of one of the dental silks of the dental floss strip according to the present invention;

FIG. 1C is an assembled, schematic view of the dental floss strip applied to a dental floss pick according to the present invention;

FIG. 2 is a flowchart of the method for manufacturing a dental floss pick with a bactericidal function;

FIG. 3 is a perspective, schematic view of the dental floss pick with a bactericidal function according to the first embodiment of the present invention;

FIG. 4 is a perspective, schematic view of the dental floss pick with a bactericidal function according to the second embodiment of the present invention; and

FIG. 5 is a perspective, schematic view of the dental floss pick with a bactericidal function according to the third embodiment of the present invention.

### DETAILED DESCRIPTION OF THE PREFERRED EMBODIMENTS

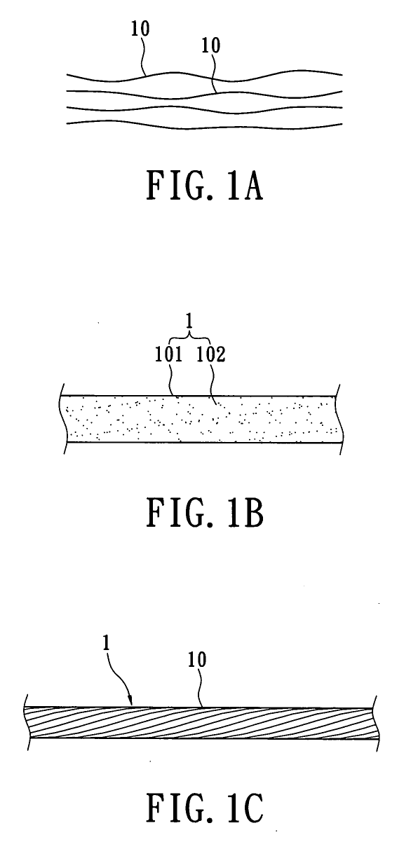

Referring to FIGS. 1A to 1C, the present invention provides a dental floss strip 1 applied to a dental floss pick, including: a plurality of dental silks 10 twisted with each other. Each dental silk 10 is composed of a first dental material 101 and a second dental material 102.

The first dental material 101 can be polymer. For example, the first dental material 101 can be selected from the group consisting of nylon, polyester, polyethylene and polypropylene. In addition, the second dental material 102 is composed of a plurality of nano-sized silver particles that are mixed into the first dental material 101 (as shown in FIG. 1B).

Moreover, the dental silks 10 are spirally twisted with each other (as shown in FIG. 1C). When the twisted dental silks 10 are stirred by a predetermined force, one part of the nano-sized silver particles that have been mixed in the first dental material 101 may be separated from the first dental material 101. For example, some nano-sized silver particles attached to the outer surface of the first dental material 101 may be separated from the first dental material 101. Hence, when the dental floss strip I is applied to clean teeth, the dental floss strip 1 can generate bactericidal function. Hence, when one part of the nano-sized silver particles that have been mixed in the first dental material 101 is separated from the first dental material 101, the nano-sized silver particles can kill bacteria in the oral cavity in order to avoid periodontal disease. For example, when a user uses the dental floss strip 1 to clean teeth, one part of the nano-sized silver particles that have been mixed in the first dental material 101 is separated from the first dental material 101 by vibrating the dental floss strip 1 in order to achieve bactericidal activity.

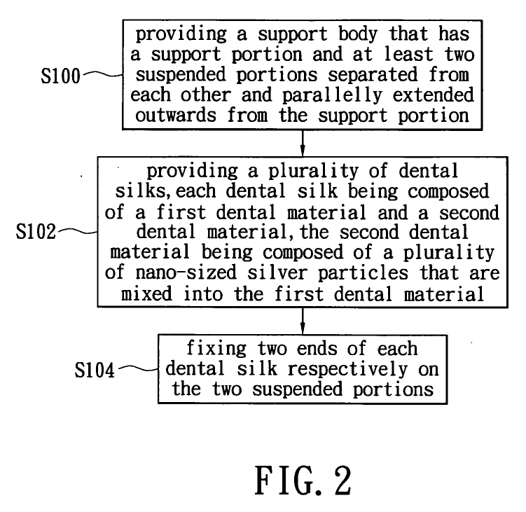

Referring to FIG. 2, the prevent invention provides a method for manufacturing a dental floss pick with a bactericidal function, including: providing a support body that has a support portion and at least two suspended portions separated from each other and parallelly extended outwards from the support portion (S100); providing a plurality of dental silks, each dental silk being composed of a first dental material and a second dental material, the second dental material being composed of a plurality of nano-sized silver particles that are mixed into the first dental material (S102); and then fixing two ends of each dental silk respectively on the two suspended portions (S104). Therefore, when the twisted dental silks are stirred by a predetermined force, one part of the nano-sized silver particles that have been mixed in the first dental material may be separated from the first dental material.

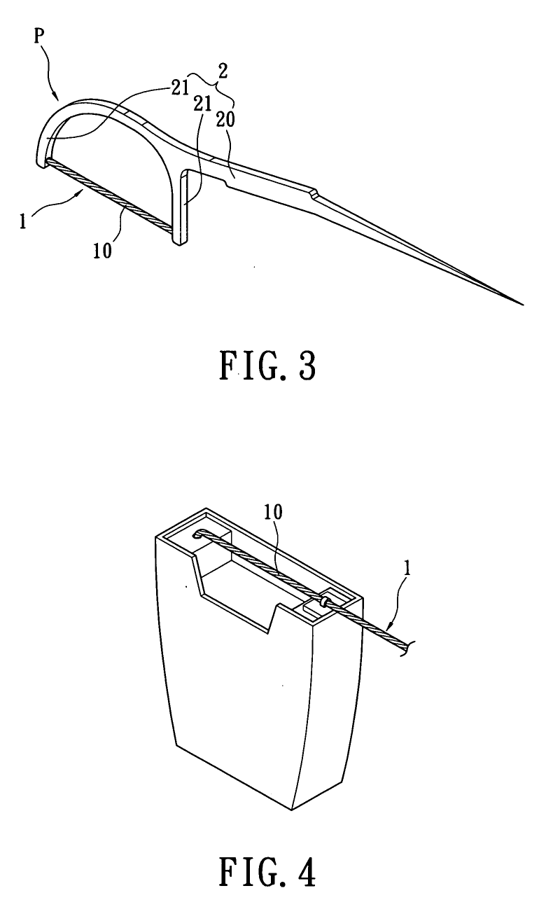

Referring to FIG. 3, the first embodiment of the present invention provides a dental floss pick P with a bactericidal function by using the method of FIG. 2. The dental floss pick P includes a support body 2 and a plurality of dental silks 10.

The support body 2 can be made of environmental plastic material, and the support body 2 has a support portion 20 and at least two suspended portions 21 separated from each other and parallelly extended outwards from the support portion 20. In addition, the dental silks 10 are spirally twisted with each other to form a dental floss strip 1 in order to respectively fix the two ends of each dental silk 10 on the two suspended portions 21. The same as FIGS. 1A to 1C, each dental silk 10 is composed of a first dental material 101 and a second dental material 102, and the second dental material 102 is composed of a plurality of nano-sized silver particles that are mixed into the first dental material 101.

Hence, when the dental floss strip 1 is applied to clean teeth, the dental floss strip 1 can generate bactericidal function. For example, when one part of the nano-sized silver particles that have been mixed in the first dental material 101 is separated from the first dental material 101, the nano-sized silver particles can kill bacteria in the oral cavity in order to avoid periodontal disease.

Referring to FIG. 4, the second embodiment of the present invention provides a dental floss pick P′ with a bactericidal function by using the method of FIG. 2. The dental floss pick P′ includes a support body 2 and a plurality of dental silks 10.

The support body 2 can be made of environmental plastic material, and the support body 2 has a support portion 20 and at least two suspended portions 21 separated from each other and parallelly extended outwards from the support portion 20. In addition, the dental silks 10 are spirally twisted with each other to form a dental floss strip 1 in order to respectively fix the two ends of each dental silk 10 on the two suspended portions 21. The same as FIGS. 1A to 1C, each dental silk 10 is composed of a first dental material 101 and a second dental material 102, and the second dental material 102 is composed of a plurality of nano-sized silver particles that are mixed into the first dental material 101.

The difference between the second embodiment and the first embodiment is that: the dental floss strips 1 are separated from each other by a predetermined distance and the dental floss strips 1 are parallelly disposed between the two suspended portions 21. Hence, when the dental floss strip 1 is applied to clean teeth, the dental floss strip 1 can generate bactericidal function. Hence, when one part of the nano-sized silver particles that have been mixed in the first dental material 101 is separated from the first dental material 101, the nano-sized silver particles can kill bacteria in the oral cavity in order to avoid periodontal disease.

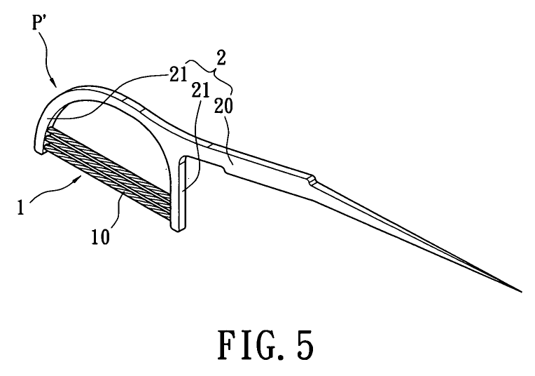

Referring to FIG. 5, the third embodiment of the present invention provides a dental floss box with a bactericidal function by using the method of FIG. 2. The dental floss box includes a box and a dental floss strip 1. The dental floss strip 1 is composed of a plurality of dental silks 10 that are spirally twisted with each other. The same as FIGS. 1A to 1C, each dental silk 10 is composed of a first dental material 101 and a second dental material 102, and the second dental material 102 is composed of a plurality of nano-sized silver particles that are mixed into the first dental material 101.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A dental floss strip applied to a dental floss pick, comprising: a plurality of dental silks twisted with each other, wherein each dental silk is composed of a first dental material and a second dental material, and the second dental material is composed of a plurality of nano-sized silver particles that are mixed into the first dental material, whereby when the twisted dental silks are stirred by a predetermined force, one part of the nano-sized silver particles that have been mixed in the first dental material may be separated from the first dental material.

2. The dental floss strip according to claim 1, wherein the first dental material is polymer.

3. The dental floss strip according to claim 1, wherein the first dental material is selected from the group consisting of nylon, polyester, polyethylene and polypropylene.

4. The dental floss strip according to claim 1, wherein the dental silks are spirally twisted with each other.

5. A dental floss pick with a bactericidal function, comprising:
a support body having a support portion and at least two suspended portions separated from each other and parallelly extended outwards from the support portion; and
a plurality of dental silks, each dental silk having two ends respectively fixed on the two suspended portions, wherein each dental silk is composed of a first dental material and a second dental material, and the second dental material is composed of a plurality of nano-sized silver particles that are mixed into the first dental material;
whereby when the twisted dental silks are stirred by a predetermined force, one part of the nano-sized silver particles that have been mixed in the first dental material may be separated from the first dental material.

6. The dental floss pick according to claim 5, wherein the first dental material is polymer.

7. The dental floss pick according to claim 5, wherein the first dental material is selected from the group consisting of nylon, polyester, polyethylene and polypropylene.

8. The dental floss pick according to claim 5, wherein the dental silks are spirally twisted with each other to form a dental floss strip.

9. The dental floss pick according to claim 5, wherein the dental silks are divided into a plurality of dental floss strips, the dental silks of each dental floss strip are twisted with each other, and the dental floss strips are separated from each other by a predetermined distance.

10. The dental floss pick according to claim 5, wherein the dental floss strips are parallelly disposed between the two suspended portions.

11. A method for manufacturing a dental floss pick with a bactericidal function, comprising:
providing a support body that has a support portion and at least two suspended portions separated from each other and parallelly extended outwards from the support portion;
providing a plurality of dental silks, wherein each dental silk is composed of a first dental material and a second dental material, and the second dental material is composed of a plurality of nano-sized silver particles that are mixed into the first dental material; and
fixing two ends of each dental silk respectively on the two suspended portions, wherein when the twisted dental silks are stirred by a predetermined force, one part of the nano-sized silver particles that have been mixed in the first dental material may be separated from the first dental material.

12. The method according to claim 11, wherein the first dental material is polymer.

13. The method according to claim 11, wherein the first dental material is selected from the group consisting of nylon, polyester, polyethylene and polypropylene.

14. The method according to claim 11, wherein the dental silks are spirally twisted with each other to form a dental floss strip.

15. The method according to claim 11, wherein the dental silks are divided into a plurality of dental floss strips, the dental silks of each dental floss strip are twisted with each other, and the dental floss strips are separated from each other by a predetermined distance.

16. The method according to claim 15, wherein the dental floss strips are parallelly disposed between the two suspended portions.
